(19) United States
(12) Patent Application Publication
(10) Pub. No.: US 2014/0214695 A1
(43) Pub. Date: Jul. 31, 2014

(54) SYSTEM AND METHOD TO VALUATE INTANGIBLE ASSET

(71) Applicant: Alon Konchitsky, Santa Clara, CA (US)

(72) Inventor: Alon Konchitsky, Santa Clara, CA (US)

(21) Appl. No.: 13/904,760

(22) Filed: May 29, 2013

Related U.S. Application Data
(60) Provisional application No. 61/756,461, filed on Jan. 25, 2013.

(51) Int. Cl. G06Q 30/02

(52) U.S. Cl. CPC G06Q 30/0278
USPC 705/306

(57) ABSTRACT

Embodiments of the present invention describe a system and a corresponding method for valuating one or more patent applications. The system includes various modules to receive and analyze one or more main patent application to determine attributes for comparison with attributes of each of a plurality of reference applications. Further, a value determination module of the system may determine an aggregate dollar value for the main application based on a capital value for each element of the main application. Here, the capital value for each element is determined based on comparing the main application with each of the reference applications.

### TECHNICAL FIELD

The invention relates to evaluation of a patent document and more particularly, the invention relates to a system and a method for evaluating a dollar value of a patent.

### BACKGROUND OF THE INVENTION

With the increase in the technology sector, patents are becoming an increasingly crucial asset of various organizations. Current scenario of technical advancements encourages existing technological industries to spend more money for increasing patents assets. For making decisions regarding entering into a new market, acquiring a company or for other strategic business decisions, an organization's patent asset is measured. Due to this, big corporations spend untold billions managing their staggering portfolios.

Further, in any area of business, assets valuation, such as patents' valuation, is of great importance that comes into play in a wide variety of circumstances. For example, intangible assets, such as patents, are required to be estimated in case of purchase or sale of assets, the merger or acquisition of a firm, licensing, strategic development, collateralization, tax planning, securities compliance, litigation, and the like. As a result of the immense strategic importance of patents, valuing patents and patent portfolios has become vital to all businesses.

Valuation of any patent involves typical consideration of various factors such as cost, market strength of the patent and the like. Generally, firms hire team of highly paid experts to spend substantial time for analyzing and evaluating large patent portfolios to determine patent valuation. Further, a single firm might hold tens of thousands of patents, and offer and thousands of evolving products and services and routinely hiring experts in each sector for value estimation of each patent can be cost-prohibitive to even large businesses under ordinary circumstances.

Further advancement brings an alternative to the costly manual valuation process that is the use of an automated valuation system for evaluating patents. However, such automated systems are largely inaccurate and inconsistent due to various reasons such as due to lack of available information, failing to employ an algorithm for considering the available data. For an instance, the existing techniques use a simple approach of considering the subject areas of a particular patent in relation to industry market-share to provide a score to a patent. However, the output through such techniques is mainly inaccurate. Other techniques such as discounted cash flow, cost, industry size, and the like also fail to account for other elements critical to consistently yielding accurate valuations.

Additionally, the existing arts evaluate a static value that is set for a patent application. However, due to ever advancing scenario of technical world, the valuation for a patent done at a particular time may not hold valid at another time. Further, due to this, the same whole procedure for scoring the patent needs to be repeated at different times of need to attain accuracy in scoring a patent at a particular time and thus demands for extra time and cost.

Thus, based on the aforementioned, there is a need of a system and a corresponding method to determine an accurate value of a patent or a patent portfolio. Further, the system should be able to evaluate a patent (or patent portfolio) in a way that reduces the requirement of extra time and cost for estimating a patent or a patent portfolio accurately.

### SUMMARY

In an embodiment of the present invention, a system for valuating an intangible asset is provided. The system includes a receiving module, an analysis module, a comparison module and a value determination module. The receiving module may be configured to receive a main application corresponding to the intangible asset. Further, the analysis module for analyzing the main application to determine one or more attributes corresponding to the main application. The comparison module may compare the main application with each of a plurality of reference applications stored in a database. The main application is compared with each of the plurality of reference applications based on the determined one or more attributes. The value determination module may determine an aggregate dollar value for the main application based on a capital value for each of one or more elements of the main application. Here, the capital value for each of the one or more elements is determined based on comparing the main application with each of the plurality of reference applications.

In another embodiment of the present invention, a method of valuing an intangible asset is provided. The method may include receiving a main application corresponding to the intangible asset. Further, the method may include analyzing the main application to determine one or more attributes corresponding to the main application. Furthermore, the method may include comparing the main application subsequently with each of a plurality of reference applications. The main application may be compared with each of the plurality of reference applications based on the determined one or more attributes. The method may further determine an aggregate dollar value for the main application based on a capital value for each of one or more elements of the main application. The capital value for each of the one or more elements is determined based on comparing the main application with each of the plurality of reference applications.

In yet another embodiment of the present invention, a computer program product for use with a computer is provided. The computer program product includes a non-transitory computer usable medium having a computer readable program code embodied therein for valuating an intangible asset. The computer readable program code when executed performing a method. The method may include receiving a main application corresponding to the intangible asset. The method may further include analyzing the main application to determine one or more attributes corresponding to the main application. Further, the method may include comparing the main application subsequently with each of a plurality of reference applications. The main application compared with each of the plurality of reference applications based on the determined one or more attributes. Furthermore, the method may include determining an aggregate dollar value for the main application based on a capital value for each of one or more elements of the main application. The capital value for each of the one or more elements is determined based on comparing the main application with each of the plurality of reference applications.

Hereinabove, the system may include an optimization module that may be implemented for optimizing performance in a subsequent iteration of determining the aggregated dollar value of the main application with respect to a subsequent reference application from the plurality of reference applications.

### BRIEF DESCRIPTION OF THE DRAWINGS

Having thus described the invention in general terms, reference will now be made to the accompanying drawings, which are not necessarily drawn to scale, and wherein

FIG. 1 illustrates an exemplary environment where various embodiments of the present invention are implemented;

FIG. 2 illustrates a block diagram of a system for valuating an intangible asset, in accordance with an embodiment of the invention;

FIG. 3 illustrates a block diagram of a system for valuating an intangible asset, in accordance with another embodiment of the invention;

FIG. 4 illustrates a database for storing information corresponding to one or more patents, in accordance with an embodiment of the present invention; and

FIG. 5 illustrates a flow diagram of a method for valuing an intangible asset, in accordance with an embodiment of the invention.

### DETAILED DESCRIPTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

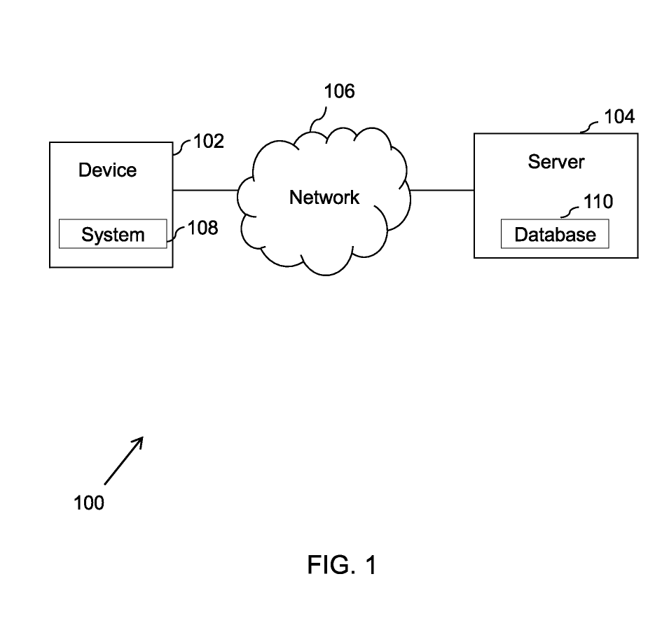

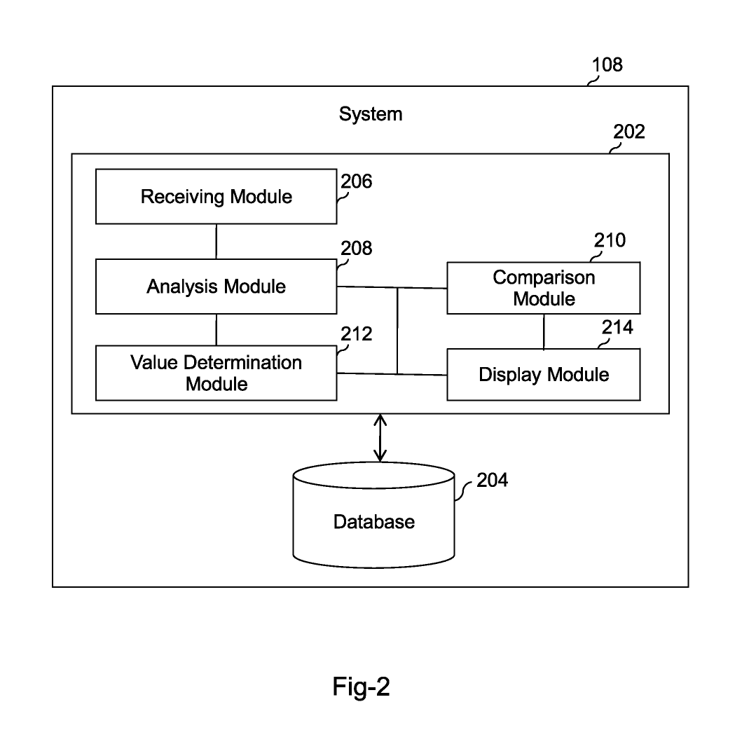

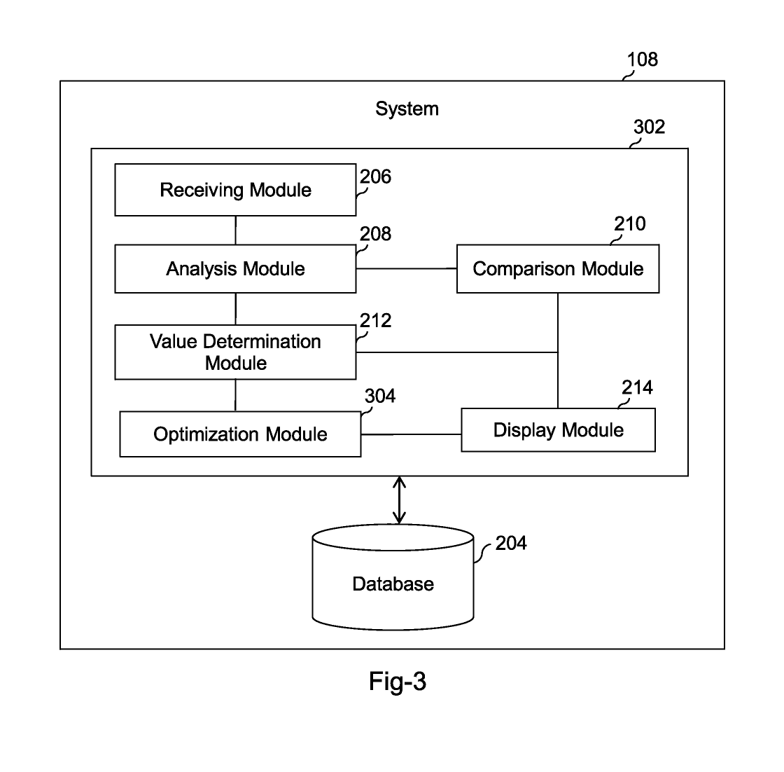

FIG. 1 illustrates an exemplary environment 100 where various embodiments of the present invention are implemented. Further, FIG. 1 illustrates a device 102 that may be communicably connected to a server 104 through a network 106 for implementing a system 108. The device 102 may include, but is not restricted to, a personal computer, a laptop, a mobile phone, a smart-phone or any other device capable of data communication. Examples of the network 106 may include any wired or wireless network, such as but not limited to, a Local Area Network (LAN), a Wide Area Network (WAN), a Wi-Fi network and so forth. The server 104 may include a database, such as a database 110 that may include a plurality of applications corresponding to an intangible asset, such as a patent. Such plurality of applications may be utilized by the system 108 for valuing a patent or a patent portfolio. Hereinafter, the plurality of applications that are stored in the database, such as the database 110, and utilized by the system 108 may interchangeably be referred to as ‘reference applications’. In an embodiment, the database 110 may be present in the device 102 or may be a part of the system 108 (shown in FIGS. 2 and 3).

The system 108 may have various modules (described further in conjunction with FIGS. 2 and 3) with one or more instructions that may be executed to determine value of a patent (hereinafter, may interchangeably be referred to as ‘main patent’). The system 108 may perform a syntactic analysis of an application corresponding to the main patent to determine one or more attributes thereof. Hereinafter, the attributes of the main patent may interchangeably be referred to as ‘main patent attributes’. Further, the system 108 may receive one or more reference applications from the database for comparing each received reference application with the application of the main patent (hereinafter referred to as ‘main patent application’). Each received reference application may also be analyzed syntactically for determining one or more attributes thereof. Hereinafter, the one or more attributes of each analyzed reference application may interchangeably be referred to as ‘reference patent attributes’. The main patent attributes and the reference patent attributes may include, but are not restricted to, claims, filing date, citations, cross reference patent applications, patent classification and so on.

Based on the determined attributes, the system 108 may compare attributes of the main patent with attributes of each reference patent subsequently to determine a capital value for each element of the main patent. The elements of the main patent may correspond to, but is not restricted to, a legal quality, a commercial quality, a field of use quality, and a technology quality of the main patent. The system 108 may further determine an aggregate dollar value for the main application with respect to each reference patent application based on a capital value for each of the element of the main application. The aggregate dollar value of the main patent is explained further in conjunction with FIGS. 2, 3 and 4.

Further, subsequent to determining the dollar value of the main patent with respect to a first received reference patent application (in a first iteration), the system 108 may further determine a dollar value (of the main patent) with respect to a subsequent reference patent application (in second iteration) that may be a second reference patent received from the database 110. Furthermore, in an embodiment, the system 108 may optimize performance in a subsequent iteration (such as in the second iteration, subsequent to the first iteration) of determining the aggregated dollar value of the main application with respect to a subsequent reference application (such as the second reference patent application, after the first received reference) from the plurality of reference applications stored in the database 110. The system 108 is further explained in conjunction with FIGS. 2 and 3.

FIG. 2 illustrates a block diagram of a system, such as the system 108 for valuating an intangible asset, in accordance with an embodiment of the invention. The system 108 may include various modules that may be stored in a memory (not shown) of the system. Each module may include a set of executable instructions that may be executed to value the intangible asset, such as a patent. Further, it may be appreciated by a person skilled in the art that the system 108 may also determine a dollar value for a patent portfolio containing a plurality of patents that may have different attributes.

Specifically, as shown, FIG. 2 depicts the system 108 having one or more modules (depicted by a block 202) and a database 204. In an embodiment, the database, such as the database 204, may be remotely located on a server (not shown) that may be accessed by the system 108. The database 204 may include a number of live and active patents that may be published across the world. The published applications stored by the database 204 may be published in English, such as USA English. The published applications that are stored in the database 204 may be referred by the system 108 (hereinafter, may be referred to as ‘reference application’) for determining a dollar value of a patent (may be referred to as ‘main patent’).

As shown, the system 108 may include, but is not limited to, a receiving module 206, an analysis module 208, a comparison module 210, a value determination module 212 and a display module 214. The receiving module 206 may receive an application corresponding to an intangible asset, such as a patent or a patent portfolio, for valuation thereof. Hereinafter, an application corresponding to the patent (that needs to be valued) may be referred to as a ‘main application’. Further, the receiving module 206 may receive a plurality of reference patent applications from the database 204. The reference patent applications may be utilized by the system 108 to determine a dollar value for the main application.

The received main application may be analyzed by the analysis module 208 to determine one or more attributes corresponding to the main application. The analysis module 208 may parse the main application to perform a syntactic analysis of the main application for determining one or more attributes of the main application. Hereinafter, the attributes of the main application may interchangeably be referred to as ‘main application attributes’. Examples of the main application attributes may include, but are not limited to, claims, filing date, cross reference patent, citation, and patent classification.

Similarly, each of the reference patent applications may be parsed subsequently by the analysis module 208 for performing syntactical analysis of each of the reference patent application. The analysis of each reference patent application is performed to determine one or more attributes corresponding to the analyzed reference application (hereinafter referred to as ‘reference application attributes’). Thus, each reference application is analyzed subsequently to determine the corresponding attributes subsequently. The reference application attributes may include, but are not limited to, claims, filing date, cross reference patent, citation, and patent classification.

The comparison module 210 may compare the main application with each of the plurality of reference applications stored in a database. The main application compared with each of the plurality of reference applications based on the determined one or more attributes of the main application and each of the reference application. For example, the comparison module 210 may compare US or international classification of the main application with US or international classification of the first reference application. Further, in an embodiment, on matching of the classification of the main application and the first application, the comparison module 210 may compare claims of the main application with claims of a first reference application for determining novelty aspect of the main application. The result of the comparison module 210 may be received by the value determination module 212 to determine dollar value of the main application.

Subsequent to the comparison of the attributes of the main application with the first reference application, the comparison module 210 may further compare the attributes of the main application with a second reference application that may be subsequent to the first reference application in the plurality of reference application. Herein, the plurality of reference applications may be a list of published applications. Thus, the comparison module 210 may compares the main application with each of the reference application of the plurality of reference applications stored in the database 204.

The value determination module 212 may analyze the result of comparison (performed by the comparison module 210) and determine a capital value for each of one or more elements of the main application. The one or more elements may include at least one of a legal quality, a commercial quality, a field of use quality, and a technology quality of the main application.

For example, the element ‘legal quality’ of the main patent may be determined through various factors such as, but are not limited to, enforceability, relevancy strength, novelty, breadth, validity confidence interval, opposition survivability estimate and litigation avoidance probability. Similarly, the element ‘commercial quality’ of the main patent may be determined through factors such as citation value contribution, enforcement licensing potential partner licensing potential, market activity, market strength, license opportunities, and commercial metrics such as potential licensees, number of patents owned by the same assignee, and the like. Further, the elements such as ‘technology quality’ may be determined through technology advancement measurement, technical sophistication, combinatorial accession. The main application may be assessed for such factors based on comparison with each of the reference applications.

On receiving the result of comparison between various attributes of the main application and each of the reference applications, the value determination module 212 may determine capital value for each element of the main application. For example, if it is determined (based on the comparison between claims of the main application and the reference applications) that claims of the main application is not matching with claims of any of the reference applications then the value determination module 212 may determine the claims of the main application as novel with respect to the reference applications. Accordingly, the value determination module 212 may determine a higher capital value for the factor ‘novelty’ and thereby, for the element ‘legal quality’.

Similarly, the value determination module 212 may determine capital value for other elements such as ‘commercial quality, a field of use quality, and a technology quality of the main application. In an embodiment of the present invention, for determining a capital value for any element (such as legal quality, commercial quality, technology quality) of the main patent, the value determination module 212 may determine values for each corresponding factor of the main application. For example, in this embodiment, to determine the capital value of the legal quality of the main application, the value determination module 212 may determine value for each factor such as novelty, enforceability, relevancy strength and the like (as described above) of the main application.

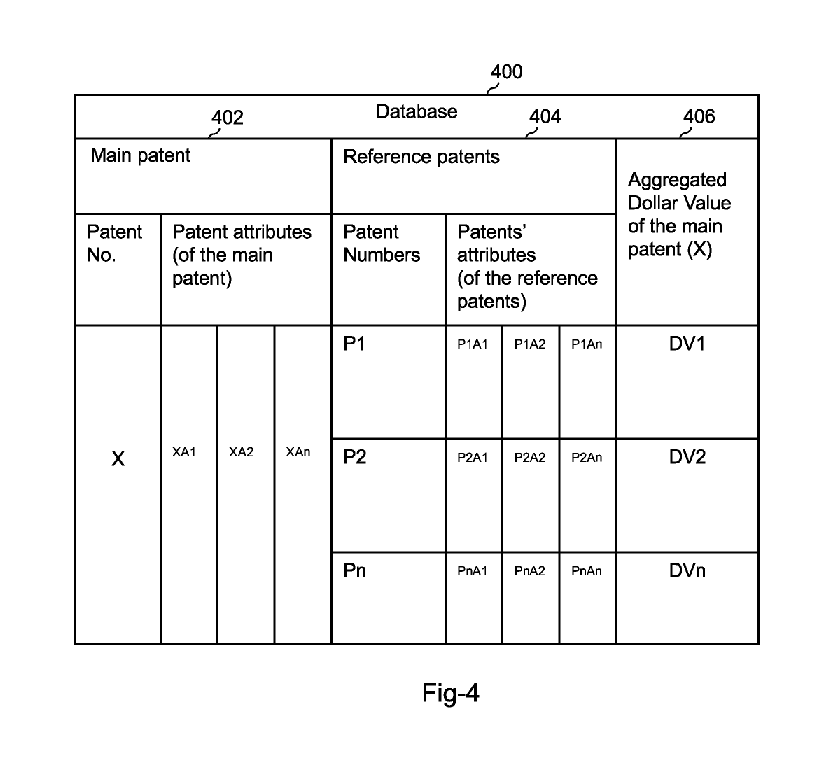

Further, the value determination module 212 may determine an aggregated dollar value for the main application based on a capital value for each of one or more elements of the main application. The determined aggregated dollar value of the main application may be stored in the database 204. Further, the display module 214 may present the determined aggregated dollar value of the main application to a graphical user interface of a device, such as the device 102 (as shown in conjunction with FIG. 1). The aggregated dollar value for the main application is explained further in conjunction with FIG. 4.

Further, with enhancement in technology and patents, the database 204 containing published applications may change with time. Thus, to maintain accuracy in determining the dollar value of the main patent, it may be appreciated by a person skilled in the art that an optimization module may be implemented by the system 108 of the present invention. The optimization module is explained in conjunction with FIG. 3.

FIG. 3 illustrates a block diagram of a system for valuating an intangible asset, in accordance with another embodiment of the invention. As depicted, the system 108 may include one or more modules 302 and a database, such as the database 204. Specifically, the system 108 may include, but is not restricted to, the receiving module 206, the analysis module 208 communicably coupled to the receiving module 206 and the comparison module 210, the comparison module 210 (communicably coupled to the value determination module 212), the value determination module 212 (communicably connected to the comparison module 210 and an optimization module 304), the display module 214 and the optimization module 304.

The receiving module 206, the analysis module 208, the comparison module 210, the value determination module 212, and the display module 214 are explained previously in conjunction with FIG. 2 and thus not repeated here in detail for the sake of brevity. Further, the optimization module 304 may optimize performance in a subsequent iteration while determining the aggregated dollar value of the main application with respect to a subsequent reference application from the plurality of reference applications. The optimization module 304 may include an adaptive filter to implement an adaptive process based on the dynamic database for maintaining accuracy in determining dollar value for the main application.

In an embodiment, the adaptive process may commence with one or more initial conditions, such as an initial number. Such initial number may progress over time due to changes in the database and thus, a value to the initial number may be added in each subsequent iteration of determining dollar value of the main patent with respect to each subsequent reference patent application. For example, if the initial value of the main application is equal to a base value then the current value may include addition of a delta to the initial value. Herein, the delta may be a variation due to change in the database that may be determined on subsequent comparisons of the attributes of the main application with the database. Further, in an embodiment, the database 204 may be updated with the optimized value of the main patent during iterations of comparison of the main patent with the database.

Referring now to FIG. 4 that illustrates a database 400 for storing information corresponding to one or more patents, in accordance with an embodiment of the present invention. As depicted, the database 400 may include information corresponding to the main patent 402 that may need to be valued. Further, the database 400 may include a list of granted patents or patent applications published across the world. Such published patent applications may be referred by the system to determine dollar value for a patent or a patent portfolio. Such patent or patent portfolio may hereinafter be referred to as ‘main patent’ or ‘main portfolio’. Further, hereinafter, the published patent applications that may be referred by the system may be referred to as ‘reference applications’. Further, as shown, the aggregated dollar value of the main patent that may be determined with respect to each reference application may be stored in the database 400.

As shown, the information in column 402 depicts patent number ‘X’ and attributes of the main patent (such as XA1, XA2 and so on till XAn) that may need to be valuated. The attributes (A1, A2, . . . , An) may include, but are not limited to, claims, filing date, citations (forward citation/backward citation), cross reference patent and patent classification. The main patent (‘X’) may need to be compared with each of the reference patents P1, P2, and so on till Pn. Herein, ‘n’ is a large finite number. Further, the database 400 may store attributes of each reference patent. For example, as shown, the attributes for the reference patent ‘P1’, may include P1A1, P1A2, and so on till P1An. Herein, A1, A2, . . . An symbolise attributes of the reference patent ‘P1’.

Similarly, as shown, the attributes for the reference patent ‘P2’, may include P2A1, P2A2, and so on till P2An. Herein, A1, A2, . . . and An are attributes of the reference patent ‘P2’. Again similar, the attributes for the reference patent ‘Pn’, may include PnA1, PnA2, and so on till PnAn. Herein, A1, A2, . . . , An are attributes of the reference patent ‘Pn’.

In an embodiment, one or more attributes of the main patent may be same as the attributes of the reference patents. For example, if the attributes of the main patents include claims, forward citations, and classifications and so on then the attributes of any reference patent may also include these attributes that may be matched by a system, such as the system 108, to determine a capital value for each element of the main patent. Herein, the main patent may be valued based on one or more elements, such as, but are not limited to, a legal quality, a commercial quality, a field of use quality, and a technology quality.

Based on the matching of the attributes of the main patent and each of the reference patents, a capital value for each element of the main patent may be determined. Accordingly, an aggregated dollar values, such as DV1, DV2, . . . , DVn may be calculated for the main patent with respect to each of the reference patents ‘P1’, ‘P2’ . . . ‘Pn’ based on the capital values for each element of the main patent. For example, if the capital values for the elements (such as legal quality, commercial quality, field of use quality and technology quality) of the main patent (‘X’) with respect to the reference patent ‘P1’ are D′V1′, D″V1″, D′″V1′″ and D″″V1″″ then in an embodiment, the aggregated dollar value for the main patent with respect to the reference patent P1 may be determined as: (D′V1′+D″V1″+D′″V1′″+D″″V1″″)/4. Further, this aggregated dollar value may be referred to as ‘DV1’ that is depicted (in the database 400) as the dollar value of the main patent with respect to the reference patent ‘P1’.

Similarly, if the capital values for legal quality, commercial quality and technology quality of the main patent ‘X’ are D′V2′, D″V2″, D′″V2′″ then in an embodiment, the aggregated dollar value of the main patent with respect to the reference patent P2 may be determined as: (D′V2′+D″V2″+D′″V2′″)/3. This aggregated dollar value may be referred to as ‘DV2’ that may depict (in the database 400) the dollar value of the main patent with respect to the reference patent ‘P2’. Further, similarly for the aggregated dollar value of the main patent ‘X’ with respect to the reference patent Pn may be determined (through the capital values of elements) as: (D′Vn′+D″Vn′+D′″Vn′″)/3. This aggregated dollar value may be referred to as ‘DVn’ that may depict (in the database 400) the dollar value of the main patent with respect to the reference patent ‘Pn’.

Further, in an embodiment, the database 400 may store an optimized dollar value of the main patent that may be determined by a system, such as the system 108, using an adaptive filter (through an optimization module of the system 108). The optimization of the dollar value of the main patent may be understood more clearly when read in conjunction with FIG. 3.

Additionally, the database 400 may be updated regularly based on changes in the attributes of any of the main patent or a reference patent. It may be appreciated by a person skilled in the art that the database 400 may not be restricted to the information as shown in FIG. 4. Further, many more information that may be utilized by the system in subsequent iterations may be stored in the database 400. Further, it may be appreciated by a person skilled in the art that the database 400 may store vast information that may further be collected automatically from various other databases and online information pools through a network, such as the network 106 (as shown in FIG. 1).

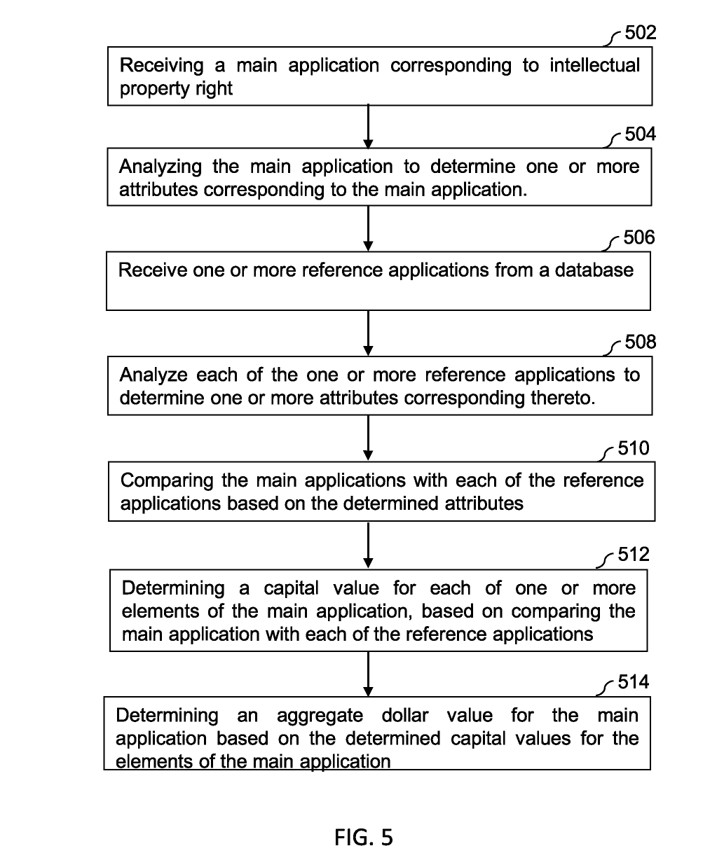

FIG. 5 illustrates a flow diagram of a method for valuing an intangible asset, in accordance with an embodiment of the invention. Herein, the intangible asset may be a patent. In an embodiment, the intangible asset may relate to any intellectual property right. The order in which the method is performed is not intended to be construed as limitation, and further any number of the method steps may be combined in order to implement the method or an alternative method without departing from the scope of the invention.

At step 502, a main application may be received corresponding to intellectual property right, such as a patent. The main application may correspond to a patent application or patent portfolio that may need to be valued. Thus, in an embodiment, one or more main patent applications (hereinafter each main patent application may be referred to as ‘main application’) corresponding to a patent or a patent portfolio may be received to be valued. Further, at step 504, the received main application may be analyzed syntactically to determine one or more attributes of the main application. The one or more attributes may include, but are limited to, claims, filing date, citations, cross reference patent applications, field of invention, and patent classification. The determined attributes may be stored in a database.

Further, at step 506, one or more reference applications may be received from the database, such as the database 400. The reference applications may be patent applications published in various countries across the world. Each of the reference applications may be analyzed syntactically at step 508 to determine one or more attributes corresponding thereto.

At step 510, the main application may be compared with the each of the plurality of reference applications based on the determined attributes of the main application and the reference application. For example, the main application may be compared with attributes of a first reference (of the plurality of references) in a first iteration. Subsequently the attributes of the main application may be compared with attributes of a subsequent reference application (in a list of the plurality of applications) in a subsequent iteration.

Further, based on comparing the main application with each reference application, the capital value for each of one or more element of the main application may be determined, at step 512. The one or more elements may include, but is not limited to, a legal quality, a commercial quality, a field of use quality, and a technology quality of the main patent. The capital value for the elements of the main application may vary based on each reference application that may be compared with the main application.

Further, at step 514, an aggregate dollar value for the main application corresponding to a specific reference application may be determined based on the capital values determined for elements of the main application. Further, the aggregate dollar value may be subsequently calculated for the main application with respect to all the reference applications stored in the database. The concepts corresponding to capital value for the elements of the main application and the aggregate dollar value for the main application with respect to a particular reference application are explained previously in conjunction with FIGS. 2 and 4 and thus, not repeated here in detail for the sake of brevity.

Further, the method described here above for valuating a patent is not limited to the steps as shown in FIG. 5. Further, many other steps may be followed to enhance the performance of the method. For example, the method may further optimize the performance in determining the aggregate dollar value of the main patent with respect to a subsequent reference application from the plurality of reference applications. Further, the method may include storing the aggregate dollar value in a database (such as the database 204, as explained in conjunction with FIG. 2) and displaying the aggregate dollar value to an interface of a device, such as the device 102 (explained in conjunction with FIG. 1). Furthermore, it may be appreciated by a person skilled in the art that the method may not be restricted to the above description of the embodiments. Further, many more embodiments may be implemented to valuate an application corresponding to intellectual property right.

Further, the method steps are explained previously in conjunction with FIGS. 2, 3 and 4 and thus the detailed explanation is not repeated here for the sake of brevity. Accordingly, various embodiments explained previously in conjunction with FIGS. 2, 3 and 4 may be implemented as steps or embodiments of the method described in FIG. 5. Further, the invention is not limited to above-mentioned embodiments and examples and many other embodiments and examples may be implemented in light of the invention without departing from the scope of the invention. Also, the usage of terminology such as ‘first’, ‘second’, ‘third’ and ‘subsequent’ should not be considered as restrictive aspect of the present invention as such terminologies are used just for the purpose of better explanation.

Advantageously, the present invention discloses a system, a method and a computer program product for valuating an intangible asset, such as a patent. The advantageous uniqueness of the present invention includes an optimized and comprehensive database that includes the majority of the active patents published by U.S. Patent and Trademark Office and also patent applications published across the world. Further, the database may be regularly updated with changing attributes of the active patents, such as forward citations of a patent may change regularly thus changes in any attribute of a live and active patent application may be updated in the database and further considered into account to determine an accurate worth of a patent application. Further, in an embodiment, the database may be updated automatically through online information pool to gain information corresponding to any new published patent application or changes in the existing active patents (those are already stored in the database).

Such performance optimized database may allow quickly and efficiently to compare a patent (such as the main patent) or a whole patent portfolio against a plurality of published patent applications (referred above as ‘reference applications’) along multiple dimensions. Further, the present invention may utilize a multi-dimensional adaptive weight index (by utilizing an adaptive filter) that may compare and determine value for various elements such as a legal quality, a commercial quality, a field of use quality, and a technology quality of the main patent. Each element may include various factors that may be evaluated for the main patent by comparing with each of the reference patent. This may enable determination of real, accurate dollar value of any patent (main application). Further, the present invention optimizes performance of the system by updating database (based on change in real scenario of patent application(s)) and accordingly, determines a real, accurate and optimized dollar value for a patent (or main application). Further, time consumption in getting such accurate real dollar value for an intangible asset is remarkably less by using the automated system of the present invention.

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions may be loaded onto one or more general purpose computers, special purpose computers, or other programmable data processing translator to produce machines, such that the instructions that execute on the computers or other programmable data processing translator create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims. The invention has been described in the general context of computing devices, phone and computer-executable instructions, such as program modules, being executed by a computer. Generally, program modules include routines, programs, characters, components, data structures, etc., that perform particular tasks or implement particular abstract data types. A person skilled in the art will appreciate that the invention may be practiced with other computer system configurations, including hand-held devices, multiprocessor systems, microprocessor-based or programmable consumer electronics, network PCs, minicomputers, mainframe computers, and the like. Further, the invention may also be practiced in distributed computing worlds where tasks are performed by remote processing devices that are linked through a communications network. In a distributed computing world, program modules may be located in both local and remote memory storage devices.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for valuating an intangible asset comprising:
a receiving module configured to receive a main application corresponding to the intangible asset;
an analysis module for analyzing the main application to determine one or more attributes corresponding to the main application;
a comparison module for comparing the main application with each of a plurality of reference applications stored in a database, the main application compared with each of the plurality of reference applications based on the determined one or more attributes; and
a value determination module for determining an aggregate dollar value for the main application based on a capital value for each of one or more elements of the main application,
wherein the capital value for each of the one or more elements is determined based on comparing the main application with each of the plurality of reference applications.

2. The system of claim 1, wherein the analysis module further configured to analyze each of the plurality of reference applications to determine one or more attributes corresponding thereto.

3. The system of claim 1, wherein, the value determination module further configured to determine the capital value for each of the one or more elements of the main application to determine the aggregate dollar value of the main application.

4. The system of claim 1, wherein the one or more elements comprise at least one of a legal quality, a commercial quality, a field of use quality, and a technology quality of the main application.

5. The system of claim 1 further comprising a display module for presenting the determined aggregate dollar value of the main application to an interface.

6. The system of claim 1, further comprising an optimization module for optimizing performance in a subsequent iteration for determining the aggregate dollar value of the main application with respect to a subsequent reference application from the plurality of reference applications.

7. The system of claim 1, wherein the receiving module further configured to receive the plurality of reference applications from the database, wherein one or more attributes of each of the received plurality of reference applications are compared with the main application subsequent to comparison of previous reference application of the received plurality of applications with the main application.

8. The system of claim 1, wherein the database is updated by storing, therein, each aggregated dollar value of the main application determined corresponding to a reference application of the plurality of reference applications.

9. A method of valuing an intangible asset comprising:
receiving a main application corresponding to the intangible asset;
analyzing the main application to determine one or more attributes corresponding to the main application;
comparing the main application subsequently with each of a plurality of reference applications, the main application compared with each of the plurality of reference applications based on the determined one or more attributes; and
determining an aggregate dollar value for the main application based on a capital value for each of one or more elements of the main application,
wherein the capital value for each of the one or more elements is determined based on comparing the main application with each of the plurality of reference applications.

10. The method of claim 9 further comprising analyzing each of the plurality of reference applications to determine one or more attributes corresponding thereto.

11. The method of claim 9, wherein the one or more attributes corresponding to the main application are compared subsequently to attributes of each reference application of the plurality of reference applications to determine the capital value for each element of the main application.

12. The method of claim 9, wherein the one or more elements comprise at least one of a legal quality, a commercial quality, a field of use quality, and a technology quality of the main application.

13. The method of claim 9 further comprising presenting the determined aggregate dollar value of the main application to an interface.

14. The method of claim 9 further comprising optimizing performance in determining the aggregate dollar value of the main application with respect to a subsequent reference application from the plurality of reference applications.

15. The method of claim 9 further comprising receiving the plurality of reference applications, wherein one or more attributes of each of the received plurality of reference applications are compared with the main application subsequent to comparison of previous reference application of the received plurality of applications with the main application.

16. The method of claim 9 further comprising storing each aggregate dollar value of the main application determined corresponding to a reference application of the plurality of reference applications.

17. A computer program product for use with a computer, the computer program product comprising a non-transitory computer usable medium having a computer readable program code embodied therein for valuating an intangible asset, the computer readable program code when executed performing a method comprising:
receiving a main application corresponding to the intangible asset;
analyzing the main application to determine one or more attributes corresponding to the main application;
comparing the main application subsequently with each of a plurality of reference applications, the main application compared with each of the plurality of reference applications based on the determined one or more attributes; and
determining an aggregate dollar value for the main application based on a capital value for each of one or more elements of the main application,
wherein the capital value for each of the one or more elements is determined based on comparing the main application with each of the plurality of reference applications.

18. The computer program product of claim 17, wherein the computer program code further performs analyzing each of the plurality of reference applications to determine one or more attributes corresponding thereto.

19. The computer program product of claim 17, wherein the computer program code performs comparing the one or more attributes corresponding to the main application subsequently to attributes of each reference application of the plurality of reference applications to determine the capital value for each element of the main application.

20. The computer program product of claim 17, wherein the one or more elements comprise at least one of a legal quality, a commercial quality, a field of use quality, and a technology quality of the main application.
